(19) United States
(12) Patent Application Publication
(10) Pub. No.: US 2023/0245147 A1
(43) Pub. Date: Aug. 3, 2023

(54) SYSTEMS AND METHODS FOR GENERATING AND VALIDATING ITEM DEMAND TRANSFER COEFFICIENTS USING DATABASE ENTRIES

(71) Applicant: Walmart Apollo, LLC, Bentonville, AR (US)

(72) Inventors: Karthik Kumaran, Sunnyvale, CA (US); Taizhou Li, San Jose, CA (US); Kenneth David Kuhn, Pasadena, CA (US); Ryan Anthony Jones, Bentonville, AR (US)

(21) Appl. No.: 17/589,798

(22) Filed: Jan. 31, 2022

(51) Int. Cl. G06Q 30/02

(52) U.S. Cl. CPC G06Q 30/0202; G06Q 30/0201

(57) ABSTRACT

A demand forecasting system includes a computing device configured to identify a timeframe including a first time period and a second time period and obtain historical data for a set of items over the timeframe and a plurality of sets of transfer coefficients. The computing device is configured to compute a weekly index for each week within the timeframe. The computing device is configured to compute a base forecast during the second time period based on the action indication, the weekly index, and historical data indicating a number of corresponding item transactions during the first time period. The computing device is further configured to adjust the base forecast based on the action indication and compute an error value. The computing device is also configured to select a first set of transfer coefficients based on the error value and implement a demand forecasting device using the first set of transfer coefficients.

### TECHNICAL FIELD

The disclosure relates generally to systems and methods for generating and validating demand transfer coefficients and more particularly to determining demand transfer coefficients based on database entries.

### BACKGROUND

Stores and ecommerce platforms offer a variety of different items for sale throughout the year. Some items are seasonal and other items may be offered year round. At times, the items offered may be replaced with other items, newer version, etc. based on customer demand or item availability.

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

The embodiments described herein are directed to a demand forecasting system and related methods. The demand forecasting system can include a computing device that is configured to identify a timeframe including a first time period and a second time period and obtain historical data for a set of items over the timeframe and a plurality of sets of transfer coefficients. The historical data includes an action indication. The computing device is further configured to, based on the historical data, compute a weekly index for each week within the timeframe. The computing device is also configured to, for each item of the set of items, compute a base forecast during the second time period based on the action indication, the weekly index, and historical data indicating a number of corresponding item transactions during the first time period. The computing device is further configured to, for each set of transfer coefficients of the plurality of sets of transfer coefficients, adjust the base forecast based on the action indication and compute an error value. The computing device is also configured to select a first set of transfer coefficients of the plurality of sets of transfer coefficients based on the error value for each item of the set of items and implement a demand forecasting device using the first set of transfer coefficients.

In another aspect, the first time period and the second time period are consecutive and a length of the first time period equals a length of the second time period.

In another aspect, the weekly index is determined by identifying a set of categories based on the set of items and selecting, from the historical data, for each week over the timeframe, a number of transactions for each item within a first category of the set of categories. The computing device is further configured to determine an average number of transactions for each item within the first category across a number of weeks within the timeframe and, for each week over the timeframe, divide the number of transactions for the corresponding week by the average number of transactions.

In another aspect, each item of the set of items corresponds to a category of the set of categories.

In another aspect, the computing device is configured to, in response to a first action of a first item of the set of items indicating the first item is new, compute the base forecast by identifying a set of stores similar to a store corresponding to the set of items and computing a proportional sale of the first item to items in each store of the set of stores. The computing device is further configured to compute an average proportional sale of the proportional sale for each store of the set of stores and determine the base forecast as the average proportional sale multiplied by item sales in the store.

In another aspect, the computing device is configured to, in response to a first action of a first item of the set of items indicating the first item is existing or deleted, compute the base forecast by, for each week of the first time period, determining a number of transactions of the first item and dividing the number of transactions by a corresponding weekly index to determine de-seasoned weekly transactions. The computing device is further configured to average the de-seasoned weekly transactions and, for each week of the second time period, compute a weekly base forecast as the average de-seasoned weekly transactions multiplied by a corresponding de-seasoned weekly transaction of the first time period. the computing device is further configured to sum the weekly base forecast for each week of the second time period as the base forecast for the first item.

In another aspect, the computing device is configured to determine each set of transfer coefficients of the plurality of sets of transfer coefficients by determining the plurality of sets of transfer coefficient parameters based on at least one parameter range. The computing device is further configured to, for each set of transfer coefficient parameters of the plurality of sets of transfer coefficient parameters and for each item of the set of items, obtain similarity scores between the corresponding item and each other item of the set of items and apply the corresponding set of transfer coefficients to remove filter similarity scores. The computing device is further configured to, for item pairs corresponding to similarity scores, compute a corresponding transfer coefficient between a first item and items corresponding to similarity scores with the first item as a weighted similarity score.

In various embodiments of the present disclosure, a method of demand forecasting is provided. In some embodiments, the method can include identifying a timeframe including a first time period and a second time period and obtaining historical data for a set of items over the timeframe and a plurality of sets of transfer coefficients. The historical data includes an action indication. The method includes, based on the historical data, computing a weekly index for each week within the timeframe. The method further includes, for each item of the set of items, computing a base forecast during the second time period based on the action indication, the weekly index, and historical data indicating a number of corresponding item transactions during the first time period and, for each set of transfer coefficients of the plurality of sets of transfer coefficients, adjusting the base forecast based on the action indication. The method also includes computing an error value, selecting a first set of transfer coefficients of the plurality of sets of transfer coefficients based on the error value for each item of the set of items, and implementing a demand forecasting device using the first set of transfer coefficients.

In various embodiments of the present disclosure, a non-transitory computer readable medium is provided. The non-transitory computer readable medium can have instructions stored thereon, wherein the instructions, when executed by at least one processor, cause a device to perform operations that include identifying a timeframe including a first time period and a second time period and obtaining historical data for a set of items over the timeframe and a plurality of sets of transfer coefficients. The historical data includes an action indication. The operations include, based on the historical data, computing a weekly index for each week within the timeframe. The operations further include, for each item of the set of items, computing a base forecast during the second time period based on the action indication, the weekly index, and historical data indicating a number of corresponding item transactions during the first time period and, for each set of transfer coefficients of the plurality of sets of transfer coefficients, adjusting the base forecast based on the action indication. The operations also include computing an error value, selecting a first set of transfer coefficients of the plurality of sets of transfer coefficients based on the error value for each item of the set of items, and implementing a demand forecasting device using the first set of transfer coefficients.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The features and advantages of the present disclosures will be more fully disclosed in, or rendered obvious by, the following detailed descriptions of example embodiments. The detailed descriptions of the example embodiments are to be considered together with the accompanying drawings wherein like numbers refer to like parts and further wherein:

FIG. 1 is a block diagram of a demand forecasting system in accordance with some embodiments;

FIG. 2 is a block diagram of a computing device implementing the demand forecasting device of FIG. 1 in accordance with some embodiments;

FIG. 3 is a block diagram illustrating an example demand forecasting module of the demand forecasting system of FIG. 1 in accordance with some embodiments;

FIG. 4 is a block diagram illustrating an example parameter tuning module of the demand forecasting system of FIG. 1 in accordance with some embodiments;

FIGS. 5A-5C are flowcharts of example methods of generating forecasted demand and a forecasted demand error in accordance with some embodiments;

FIG. 6 is a flowchart of example methods of tuning parameters based on the forecasted demand error in accordance with some embodiments; and

FIG. 7 is a flowchart of example methods of generating transfer coefficients for a variety of transfer coefficient parameters in accordance with some embodiments.

In the drawings, reference numbers may be reused to identify similar and/or identical elements.

### DETAILED DESCRIPTION

The description of the preferred embodiments is intended to be read in connection with the accompanying drawings, which are to be considered part of the entire written description of these disclosures. While the present disclosure is susceptible to various modifications and alternative forms, specific embodiments are shown by way of example in the drawings and will be described in detail herein. The objectives and advantages of the claimed subject matter will become more apparent from the following detailed description of these exemplary embodiments in connection with the accompanying drawings.

It should be understood, however, that the present disclosure is not intended to be limited to the particular forms disclosed. Rather, the present disclosure covers all modifications, equivalents, and alternatives that fall within the spirit and scope of these exemplary embodiments. The terms “couple,” “coupled,” “operatively coupled,” “connected,” “operatively connected,” and the like should be broadly understood to refer to connecting devices or components together either mechanically, electrically, wired, wirelessly, or otherwise, such that the connection allows the pertinent devices or components to operate (e.g., communicate) with each other as intended by virtue of that relationship.

A demand forecasting system may be implemented to generate a forecasted demand of a plurality of existing and new items offered for sale in store or on an ecommerce platform to identify a set of transfer coefficients that most accurately predict future sales. The demand forecasting system uses historical data to forecast demand of items for sale during a subsequent period for which the demand forecasting system has actual sales data. The demand forecasting system compares the forecasted and actual sales to determine an amount of error and identify the most accurate parameters used to predict or forecast future sales using hyperparameter tuning. For example, the demand forecasting system generates a plurality of sets of transfer coefficient parameters from which to generate predictions of future sales based on historical sales. Transfer coefficients represent an anticipated amount of demand transferred from a first item to a second item when a second item is introduced to a store. That is, a transfer coefficient may be determined between pairs of items that have been identified as similar or as possible substitutes for one another. Therefore, if three new items are introduced and considered possible substitutes for a first item, the demand forecasting system determines a value or a transfer coefficient indicated how much of the demand for the first item is reduced compared to each of the three new items in order to predict future demand for all four items.

In order to identify which set of transfer coefficient parameters result in the most accurate transfer coefficients, the demand forecasting system selects two, consecutive historical time periods to determine which set of transfer coefficients results in the least amount of error when predicting future sales of the second time period using historical data from the first time period. The demand forecasting system may determine the error for each set of transfer coefficients is determined based on the actual sales of the second time period and the forecasted sales during the second time period. The most accurate set of transfer coefficient parameters that determine the transfer coefficients used with historical data to forecast future sales may be identified by identifying which set of transfer coefficient parameters resulted in the least amount of error between actual and forecasted sales.

For example, the demand forecasting system may receive a range for each parameter of the transfer coefficient parameters and generate transfer coefficient sets for each combination of parameter values. The demand forecasting system may then generate a prediction or forecasted sales for each set of transfer coefficients and compare the resulting error to identify which set of transfer coefficients was most accurate. The transfer coefficients operate to reduce the number of similar items for which a transfer coefficient should be used, identifying an item pair as similar enough to substitute each other. The reduction in similar pairs reduces computational complexity and requires a reduced number of calculations to determine forecast demand for items of a store or ecommerce platform. The demand forecasting system reduces the number of potential item pairs for each item being considered.

The transfer coefficient parameters may include a similarity score threshold, a threshold number of items, a threshold percentage of items, and a percentage similarity score threshold of a most similar item. The similarity score threshold is a cutoff threshold reducing the number of item pairs by removing any item pair with a similarity score below the similarity score threshold, for example, 0.7 on a score scale of 0 to 1. The threshold number of items may be used when a particular item has equal to or fewer than 100 potential substitutions, resulting in the demand forecasting system selecting n number of item pairs with the highest similarity score, for example, the top three. The threshold percentage of items may be used when a particular item has greater than 100 potential substitutions, resulting in the demand forecasting system selecting m% of the number of item pairs with the highest similarity score, for example, the top 5%. The percentage similarity score threshold of the most similar item reduces the item pairs by determining the percentage similarity score threshold as a percentage of the similarity score of the most similar item and restricting the similarity score to the percentage similarity score threshold, for example, 80% of the highest similarity score.

All the above features of the demand forecasting system operate to improve the accuracy of demand forecasting and potentially assist in identifying highly substitutable items for elimination. The demand forecasting system predicts the results of adding, keeping, or deleting items from in store or online purchase, allowing an entity to predict revenues in the future based on availability or unavailability of items, which may also assist in the choice of removing or adding items for sale. The demand forecasting system may be updated at a threshold interval, for example, quarterly, to update transfer coefficients and determine what new items should be added or which items should be deleted.

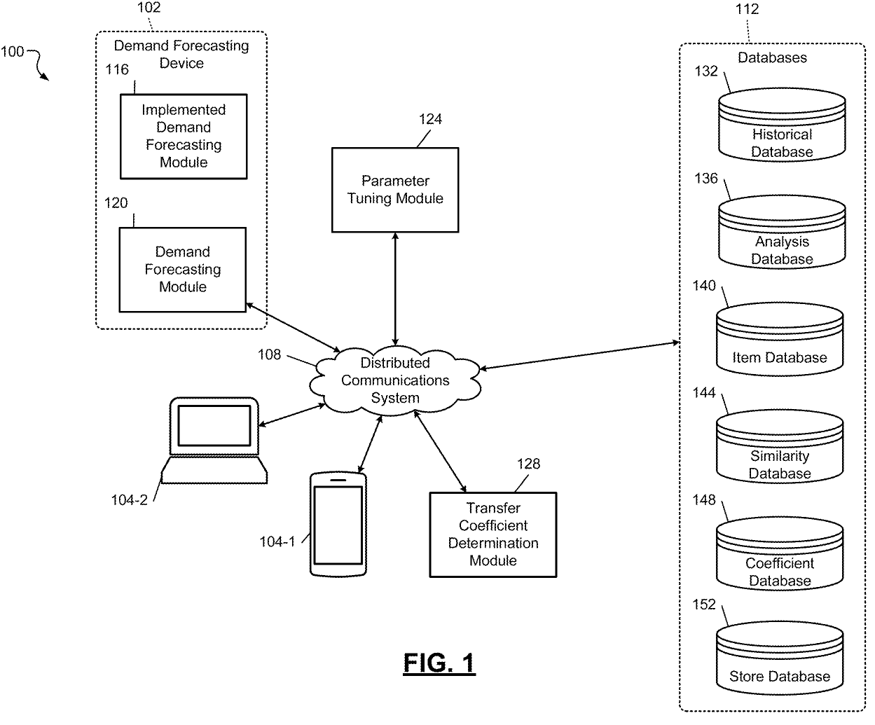

Referring to FIG. 1, a block diagram of a demand forecasting system 100 is shown. The demand forecasting system 100 may include a demand forecasting device 102 and user devices 104-1 and 104-2, collectively user device 104, such as a phone, tablet, laptop, mobile computing device, desktop, etc., capable of communicating with a plurality of databases 112 and modules via a distributed communications system 108. The user device 104 may be an analyst device capable of receiving demand forecast reports, obtaining results, submitting input data (e.g., ranges of transfer coefficient parameters), etc.

The demand forecasting system 100 also includes an implemented demand forecasting module 116, a demand forecasting module 120, a parameter tuning module 124, and a transfer coefficient determination module 128. The implemented demand forecasting module 116 receives identified thresholds from the parameter tuning module 124 after the demand forecasting module 120 identifies which transfer coefficient parameters result in the most accurate forecasting results to implement when predicting or forecasting future sales without the future sales data. In various implementations, the user device 104 may instruct the implemented demand forecasting module 116 to predict future sales for items based on actions for each item indicating whether the item is added, kept, or deleted and determine whether to add, keep, or delete items based on the forecasted sales and revenue.

The demand forecasting module 120 is implemented to test and identify the most accurate set of transfer coefficients. To do this, the demand forecasting module 120 obtains historical data from a historical database 132 over a previous time period, for example, a year, to determine a weekly sales index. Using the weekly sales index for a first time period and a plurality of transfer coefficient sets, the demand forecasting module 120 can forecast sales for a second, consecutive time period (for which the historical database 132 also stores actual sales) for each transfer coefficient set. The demand forecasting module 120 may determine an error between the actual sales of the second, consecutive time period and the forecasted sales for each set of transfer coefficients. The error and corresponding sets of transfer coefficients may be stored in an analysis database 136 for future analysis. In various implementations, reports indicating error for each set of transfer coefficients may be transmitted to the user device 104 for an analyst or other individual associated with an entity through which the items are for sale.

The parameter tuning module 124 may access the analysis database 136 to obtain the error data and corresponding sets of transfer coefficients to identify the set of transfer coefficients that result in the most accurate forecasted sales. The demand forecasting module 120 may then use the transfer coefficients generated using the identified set of transfer coefficients to generate forecasted sales for the future.

The transfer coefficient determination module 128 may generate the plurality of sets of transfer coefficients for each item for sale of an item database 140. The transfer coefficient determination module 128 obtains similarity scores for each item of the item database 140 from a similarity database 144. Based on a range for each parameter of transfer coefficient parameters, the transfer coefficient determination module 128 generates transfer coefficients for each combination of the range of transfer coefficient parameters and stores each set of transfer coefficients (and the corresponding parameters) in a coefficient database 148. In various implementations, an analyst may adjust the ranges of the parameters via an input module of the transfer coefficient determination module 128. Otherwise, the ranges may be set or vary the entirety of potential ranges (e.g., 0 to 1). The demand forecasting module 120 may obtain the variety of sets of transfer coefficients from the coefficient database 148 to generate the forecasted sales.

The transfer coefficient determination module 128 determines a transfer coefficient between similar items. That is, for each item of the item database 140, a number of similar items are identified (based on similarity scores between items stored in the similarity database 144) and the transfer coefficient from one item to another item indicates how frequently the another item would replace the one item in a transaction. The transfer coefficient between two items is similar to a substitution score in that the transfer coefficient indicates when one item can substitute for another. Since there are typically multiple substitutes for one item, computing the transfer coefficient for all similar item pairs is computationally expensive and may be unnecessary. Therefore, the transfer coefficient determination module 128 first reduces the number of item pairs indicating which items may replace another by assuming that a user would only replace a particular item with the items that are most similar to the particular item. The transfer coefficient determination module 128 may use similarity scores or similarity indices to identify those item pairs that are most similar. The transfer coefficient is then computed between the reduced set of item pairs.

For example, the transfer coefficient determination module 128 may identify a number of items that are available as substitutes for a particular item. If the number of available items is equal to or less than 100, the transfer coefficient determination module 128 may select a top number of items, for example, five items with the highest similarity score to the particular items. In various implementations, if the number of available items to substitute the particular item exceeds 100, the transfer coefficient determination module 128 may select a top percentage, for example, a top 5% of items with the highest similarity scores. Moreover, to further ensure that the item pairs are truly similar, the transfer coefficient determination module 128 may further filter the similar items by similarity score by filtering out any items below a similarity cutoff threshold. For example, the similarity cutoff threshold may be a discrete number, such as 70% similarity. In various implementations, the similarity cutoff threshold may be a percentage threshold of the highest similarity score, such as at least 80% as similar to the particular item as the most similar item. That is, with a similarity cutoff threshold of 80%, if the item that is most similar to the particular item has a similarity score of 0.64 (out of 1) results in a cutoff of 0.512 or 80% of 0.64. Therefore, any item of the top 5 items or the top 5% of items is included in an item pair with the particular item as long as the similarity score is above 0.512.

In a scenario where only one item pair is identified, the similarity score is equivalent to the transfer coefficient from the particular item to the identified similar item. Otherwise, if multiple items satisfy the top similarity score threshold and similarity cutoff threshold, the transfer coefficient is determined as a proportional value of the similarity score of the multiple items. Therefore, the transfer coefficient from a first item to a second item is the similarity score between the items multiplied by the weighting of the similarity score compared to the similarity score of the other identified items, for example, item three and item four. The transfer coefficient can be determined based on the following equation:

$$T {C}_{1 - 2} = {S}_{1 , 2} ∗ \frac{{S}_{1 , 2}}{{S}_{1 , 2} + {S}_{1 , 3} + {S}_{1 , 4}} ,$$

where TC₁₋₂ is the transfer coefficient of item 1 to item 2 (that is, item 2 replacing item 1), S_{1,2} is the similarity score between items 1 and 2, S_{1,3} is the similarity score between items 1 and 3, and S_{1,4} is the similarity score between items 1 and 4. The transfer coefficient for each of the item pairs may be calculated and stored in the coefficient database 148. That is, the transfer coefficient may be determined by weighting the similarity scores for the number of items remaining with similarity scores to the first item.

The demand forecasting system 100 also includes a store database 152 including a plurality of store identifiers indicating which stores are similar to other stores, which items are for sale at each store (including an online ecommerce platform), and historical sales data for each item of other stores. The demand forecasting system 100 may use data from other stores stored in the store database 152 to forecast demand for items not presently at a particular store based on performance at stores similar to the particular store.

The demand forecasting device 102 and the user device 104 can be any suitable computing device that includes any hardware or hardware and software combination for processing and handling information. For example, the term “device” and/or “module” can include one or more processors, one or more field-programmable gate arrays (FPGAs), one or more application-specific integrated circuits (ASICs), one or more state machines, digital circuitry, or any other suitable circuitry. In addition, each can transmit data to, and receive data from, the distributed communications system 108. In various implementations, the devices, modules, and databases may communicate directly on an internal network.

As indicated above, the demand forecasting device 102 and/or the user device 104 can be a computer, a workstation, a laptop, a server such as a cloud-based server, or any other suitable device. In some examples, demand forecasting device 102 and/or the user device 104 can be a cellular phone, a smart phone, a tablet, a personal assistant device, a voice assistant device, a digital assistant, a laptop, a computer, or any other suitable device. In various implementations, the demand forecasting device 102 is on a central computing system that is operated and/or controlled by a retailer. Additionally or alternatively, the modules and databases of the demand forecasting device 102 are distributed among one or more workstations or servers that are coupled together over the distributed communications system 108.

The databases described can be remote storage devices, such as a cloud-based server, a memory device on another application server, a networked computer, or any other suitable remote storage. Further, in some examples, the databases can be a local storage device, such as a hard drive, a non-volatile memory, or a USB stick.

The distributed communications system 108 can be a WiFi® network, a cellular network such as a 3GPP® network, a Bluetooth® network, a satellite network, a wireless local area network (LAN), a network utilizing radio-frequency (RF) communication protocols, a Near Field Communication (NFC) network, a wireless Metropolitan Area Network (MAN) connecting multiple wireless LANs, a wide area network (WAN), or any other suitable network. The distributed communications system 108 can provide access to, for example, the Internet.

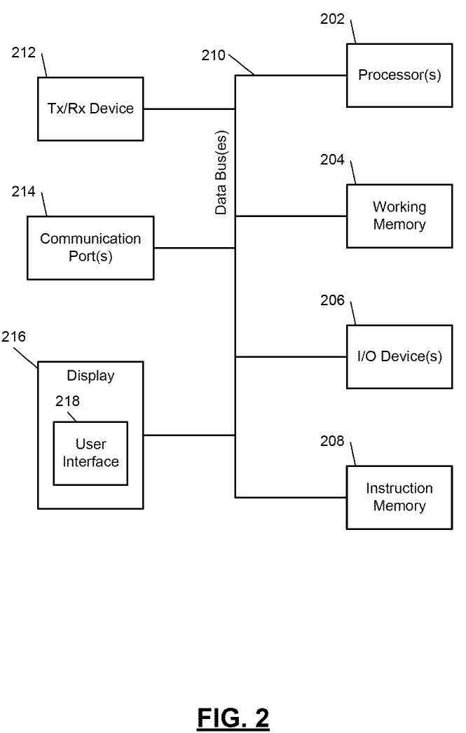

FIG. 2 illustrates an example computing device 200. The demand forecasting device 102 and/or the user device 104 may include the features shown in FIG. 2. For the sake of brevity, FIG. 2 is described relative to the demand forecasting device 102.

As shown, the demand forecasting device 102 can be a computing device 200 that may include one or more processors 202, working memory 204, one or more input/output devices 206, instruction memory 208, a transceiver 212, one or more communication ports 214, and a display 216, all operatively coupled to one or more data buses 210. Data buses 210 allow for communication among the various devices. Data buses 210 can include wired, or wireless, communication channels.

Processors 202 can include one or more distinct processors, each having one or more cores. Each of the distinct processors can have the same or different structure. Processors 202 can include one or more central processing units (CPUs), one or more graphics processing units (GPUs), application specific integrated circuits (ASICs), digital signal processors (DSPs), and the like.

Processors 202 can be configured to perform a certain function or operation by executing code, stored on instruction memory 208, embodying the function or operation. For example, processors 202 can be configured to perform one or more of any function, method, or operation disclosed herein.

Instruction memory 208 can store instructions that can be accessed (e.g., read) and executed by processors 202. For example, instruction memory 208 can be a non-transitory, computer-readable storage medium such as a read-only memory (ROM), an electrically erasable programmable read-only memory (EEPROM), flash memory, a removable disk, CD-ROM, any non-volatile memory, or any other suitable memory.

Processors 202 can store data to, and read data from, working memory 204. For example, processors 202 can store a working set of instructions to working memory 204, such as instructions loaded from instruction memory 208. Processors 202 can also use working memory 204 to store dynamic data created during the operation of the demand forecasting device 102. Working memory 204 can be a random access memory (RAM) such as a static random access memory (SRAM) or dynamic random access memory (DRAM), or any other suitable memory.

Input-output devices 206 can include any suitable device that allows for data input or output. For example, input-output devices 206 can include one or more of a keyboard, a touchpad, a mouse, a stylus, a touchscreen, a physical button, a speaker, a microphone, or any other suitable input or output device.

Communication port(s) 214 can include, for example, a serial port such as a universal asynchronous receiver/transmitter (UART) connection, a Universal Serial Bus (USB) connection, or any other suitable communication port or connection. In some examples, communication port(s) 214 allows for the programming of executable instructions in instruction memory 208. In some examples, communication port(s) 214 allow for the transfer (e.g., uploading or downloading) of data, such as data items including feedback information.

Display 216 can display a user interface 218. User interfaces 218 can enable user interaction with the demand forecasting device 102. For example, user interface 218 can be a user interface that allows an operator to review reports in a scenario where the operator is an analyst associated with an entity selling items. In various implementations, the user interface 218 can, for example, receive input from an analyst adjusting ranges or parameters of sales analyses. In some examples, display 216 can be a touchscreen, where user interface 218 is displayed on the touchscreen.

Transceiver 212 allows for communication with a network, such as the distributed communications system 108 of FIG. 1. For example, if the distributed communications system 108 of FIG. 1 is a cellular network, transceiver 212 is configured to allow communications with the cellular network. In some examples, transceiver 212 is selected based on the type of distributed communications system 108 in which the demand forecasting device 102 will be operating. Processor(s) 202 is operable to receive data from, or send data to, a network, such as the distributed communications system 108 of FIG. 1, via transceiver 212.

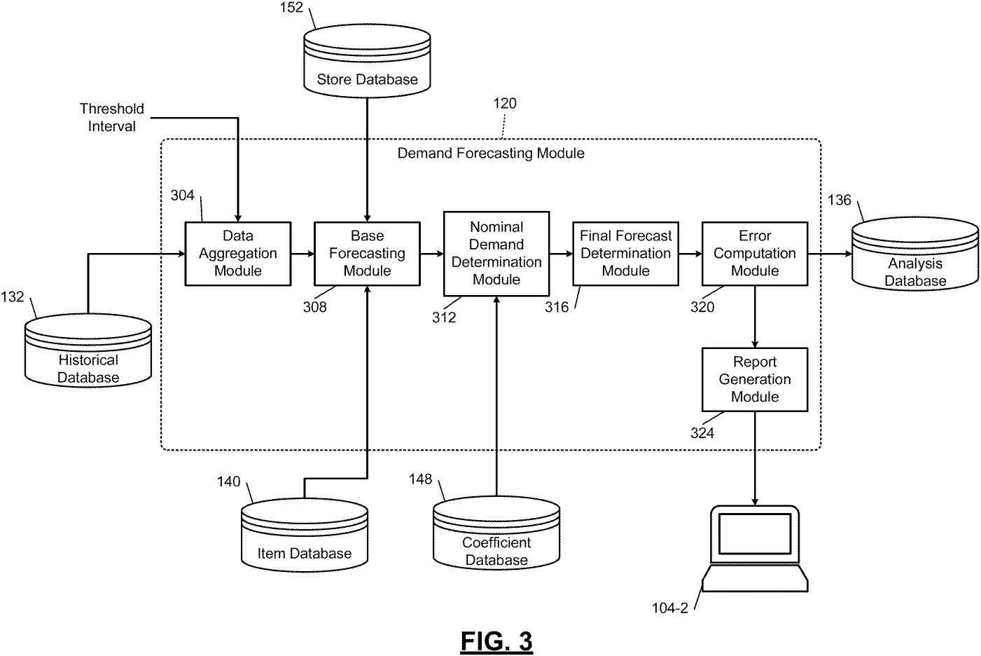

Referring to FIG. 3, a block diagram illustrating an example demand forecasting module 120 of the demand forecasting system 100 is shown. The demand forecasting module 120 may be prompted to operate for each store at a threshold interval, for example, quarterly, to determine updated transfer coefficients to most accurate forecast future item demand. In various implementations, the threshold interval prompt may indicate a store identifier. Additionally or alternatively, the threshold interval may be specifically transmitted from the user device 104 operated by an analyst of the entity or particular store.

The demand forecasting module 120 includes a data aggregation module 304 that identifies, from data stored in the historical database 132, over a threshold time period, for example one year. The data aggregation module 304 also identifies two time periods during the threshold time period that are at least a certain length, for example, at least 13 weeks. The first of the two historical time periods includes historical data that is used to predict or forecast sales during the second historical time period. Since the historical data exists for the second historical time period, the actual sales may be compared to the forecasted sales to determine which transfer coefficients used in combination with historical data of the first time period to predict or forecast future sales.

The data aggregation module 304 obtains historical sales data for items in a store or online for the threshold time period and identifies the two time periods and then forwards the historical data and identified time periods to a base forecasting module 308. The base forecasting module 308 generates a base sales forecast for each week of the second time period. For existing items, the base sales forecast for each week is determined for each item by determining a weekly category sales index by category. That is, each item corresponds to a particular category (as indicated for each item in the item database 140). The item database 140 indicates item category for existing items and item category for new to store items, based on the category of new to store items existing in other stores. In various implementations, the item database 140 also includes an indicated of an action for each item, such as during which week an item was added for sale, during what week an item was removed for sale, etc., to indicate to the base forecasting module 308 whether the item existed for all, part, or none of the first or second time period.

The weekly category sales index is determined for each category by dividing a number of item sales within each category for each week by the average number of weekly sales within the category over the threshold time period (e.g., one year) to generate a weekly category sales index for the category. If the base forecasting module 308 identifies the item as having existed during the threshold time period (e.g., any portion of the year), the base forecasting module 308 determines a de-seasoned demand for each item during the first time period by dividing, for each item, the weekly item sales by the weekly category sales index. The base forecasting module 308 determines an average weekly de-seasoned demand over the first time period. Then, to forecast the demand during each week of the second time period, the base forecasting module 308 multiples the average weekly de-seasoned demand for an item during the first time period by the weekly category sales index for each week in the second time period. The base sales forecast for each week during the second time period for each item is summed and forwarded to a nominal demand determination module 312.

If the base forecasting module 308 identifies the item as a new to store item during the threshold time period, the base forecasting module 308 implements new to store logic since the historical database 132 does not have data for the entire threshold time period. Therefore, the base forecasting module 308 may identify similar stores from the store database 152. Then, for each identified store, the base forecasting module 308 calculate proportional sales of each item as item sales within a similar store divided by overall sales within the similar store. The proportional sales across the identified similar stores is averages and then average proportional sales is multiplied by the total sales of the present store over the threshold time period to determine the base sales forecast of the new to store item over the threshold time period. The base sales forecast over the threshold time period is then adjusted based on the number of weeks within the second time period to determine the forecast sales during the second time period. The base forecast is forwarded to the nominal demand determination module 312.

The nominal demand determination module 312 iterates through each set of transfer coefficients stored in the coefficient database 148, each set corresponding to different transfer coefficient parameters. The nominal demand determination module 312 identifies new to store items and computes a nominal demand for each new to store item based on the corresponding base sales forecast and transfer coefficients between the new to store item and other new to store items. That is, the nominal demand determination module 312 sums the transfer demand for the new to store item from other new to store items to determine the nominal demand using the following equation:

$$N {D}_{i} = F {D}_{i} - {\sum }_{j = 0}^{n} F {D}_{j} ∗ T {C}_{j - i} ,$$

where NDᵢ represents the nominal demand for new to store item i, FDᵢ represents the base sales forecast for new to store item i, FDⱼ represents the base sales forecast for new to store item j, TCⱼ₋ᵢ represents the transfer coefficient from new to store item j to new to store item i, and n represents the nth new to store item where there exists a transfer coefficient from new to store item j to new to store item i.

Once the nominal demand is calculated for each of the new to store items for only transfer coefficients from new to store items to other new to store items, the nominal demand determination module 312 calculates the nominal demand for existing and deleted items from new to store items using the nominal demand of the new to store items instead of the base forecast demand of new to store items. Again, the nominal demand for existing and deleted items is only determined when the transfer to the existing or deleted item is from a new to store item and the transfer demand is summed for each transfer from new to store items using the following equation:

$$N {D}_{k} = F {D}_{k} - {\sum }_{l = 0}^{m} N {D}_{l} ∗ T {C}_{l - k} ,$$

where NDₖ represents the nominal demand for existing or deleted item k, FDₖ represents the base sales forecast for existing or deleted item k, NDₗ represents the nominal demand for new to store item l, TCₗ₋ₖ represents the transfer coefficient from new to store item l to existing or deleted item k, and m represents the mth new to store item where there exists a transfer coefficient from new to store item l to existing or deleted item k.

The nominal demand is calculated for each item with a transfer coefficient from a new to store item, otherwise, the base sales forecast is equal to the nominal demand. The purpose of reducing the base sales forecast to determine the nominal demand is to account for any replacement sales of new to store items that are similar to other items. In other words, the reduction to determine the nominal demand accounts for new to store items that are similar to other items for sale that a customer may select in place of other items.

The nominal demands for each item and each set of transfer coefficients are forwarded to a final forecast determination module 316. The final forecast determination module 316 determines a final forecast by adding demand transfers from deleted items to similar items and reducing the forecast demand for existing items by the difference between base sales forecast and nominal demand. That is, a demand transfer is calculated for items that have been identified as deleted in the second time period, the demand transfer for deleted items sums the nominal demand multiplied by the transfer coefficient for each item to which the deleted item may transfer. As described previously regarding transfer coefficients, a transfer coefficient is calculated for each similar item pair (according to transfer coefficient parameters) indicating a demand transfer from a first item to a second item. When the first item is indicated as existing during the first time period and deleted during the second time period, the demand transfer to the second item during the second time period (and to any other item indicated in the transfer coefficients from the first item). Therefore, the demand transfer (DTₒ) for deleted item o is represented as:

$$D {T}_{o} = {\sum }_{o = 0}^{q} N {D}_{o} ∗ T {C}_{o - p} ,$$

where NDₒ is the nominal demand for deleted item o, TCₒ₋ₚ is the transfer coefficient from deleted item o to similar, existing item p.

For existing items that remain existing or are being kept in the second time period, the final forecast is adjusted by the difference between the base sales forecast and nominal demand (base sales forecast - nominal demand) referred to as demand transfer cannibalization. Therefore, the final forecast of a new item is the nominal demand, the final forecast (FFᵣ) of an existing item r is represented as:

$$F {F}_{r} = N {D}_{r} - D T {C}_{r} ,$$

and the final forecast (FFₛ) of a deleted item s is represented as:

$$F {F}_{s} = N {D}_{s} + D T {D}_{s} ,$$

where DTCᵣ is the demand transfer cannibalization of existing item r and DTDₛ is the demand transfer of deleted item r. The final forecasts for each set of transfer coefficients are forwarded to an error computation module 320 to compute the error between the final forecasts of sales during the second time period and the actual sales during the second time period.

The error computation module 320 may use mean absolute percentage error (MAPE) to determine the error according to the following equation:

$$M A P E = \frac{a c t u a l - f i n a l f o r e c a s t}{a c t u a l} .$$

The error for each item and the corresponding transfer coefficient parameters used to generate the transfer coefficients are stored in the analysis database 136. In various implementations, the error may be forwarded to a report generation module 324 to generate and transmit a report of the errors immediately to user device 104-2 for analysis by an analyst associated with the entity.

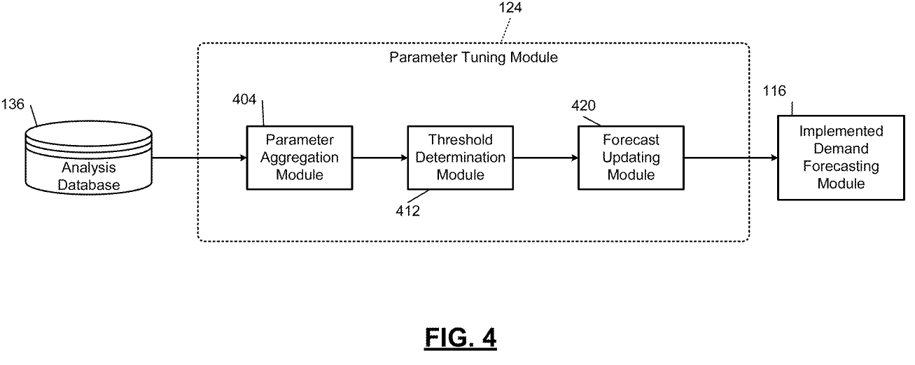

Referring now to FIG. 4, a block diagram illustrating an example parameter tuning module 124 of the demand forecasting system 100 is shown. The parameter tuning module 124 includes a parameter aggregation module 404 that obtains error computations and the corresponding transfer coefficient parameters from the analysis database 136. The collected data is forwarded to a threshold determination module 412 that identifies which set of transfer coefficient parameters results in the lowest error among all the transfer coefficient parameters to determine the threshold included in the transfer coefficient parameters. The identified threshold transfer coefficient parameters are forwarded to a forecast updating module 420. The forecast updating module 420 forwards the threshold transfer coefficient parameters and/or the corresponding transfer coefficients to the implemented demand forecasting module 116 to use the corresponding transfer coefficients to forecast future sales for items.

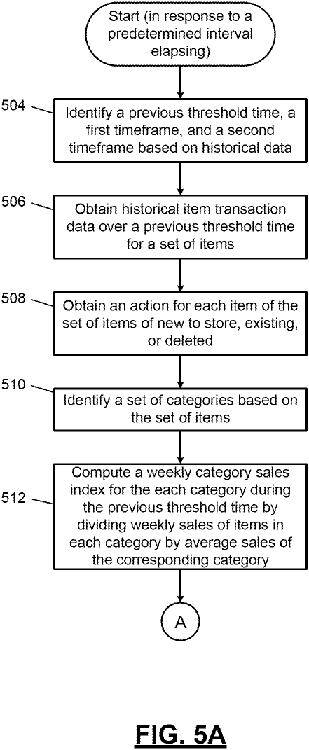

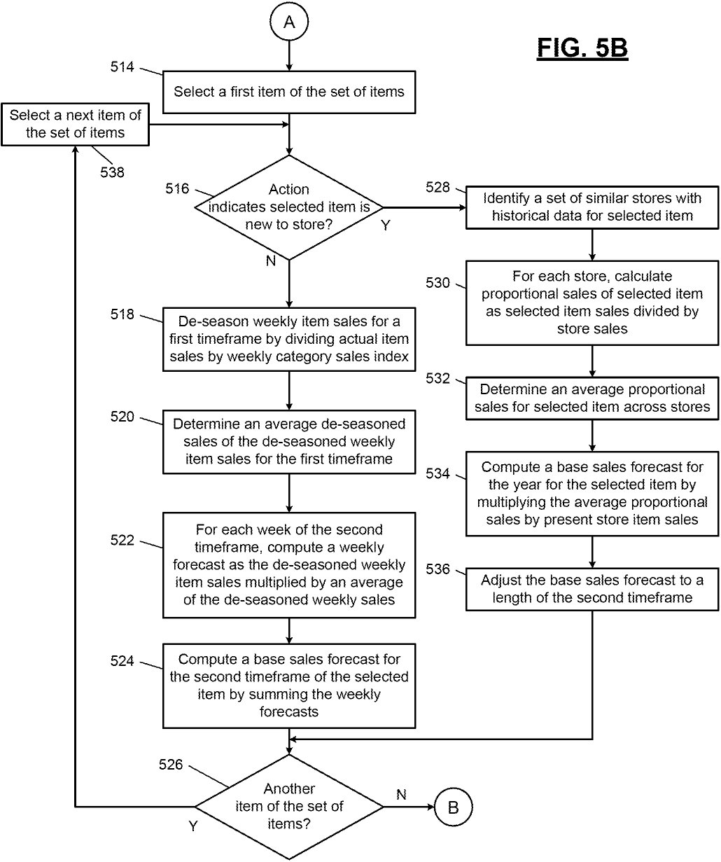

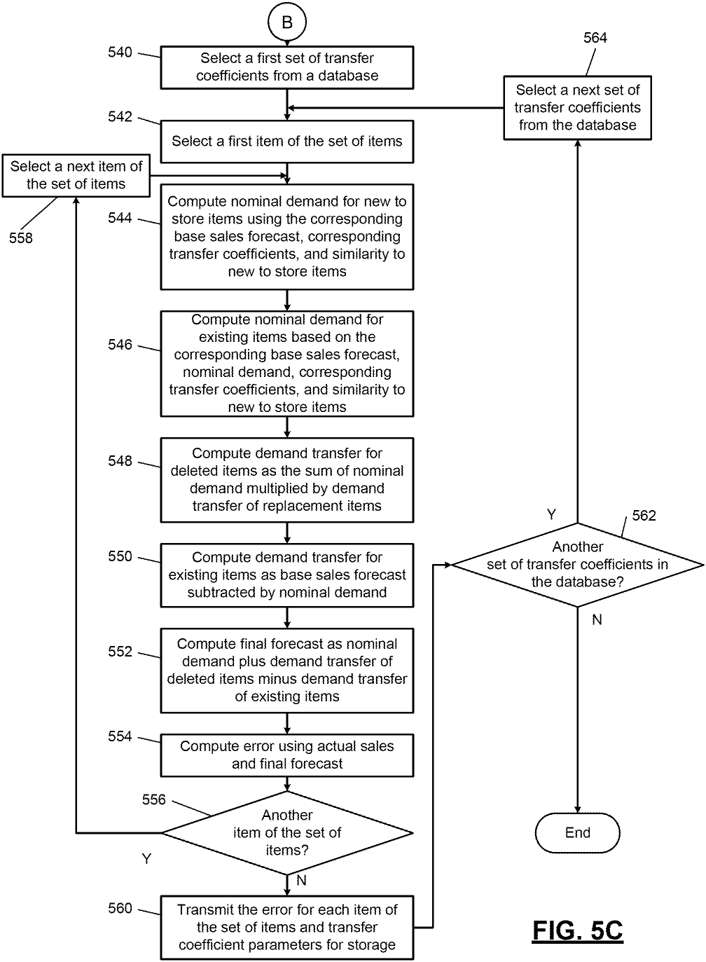

Referring to FIGS. 5A-5C, flowcharts of example methods of generating forecasted demand and a forecasted demand error is shown. Control begins in response to a predetermined interval elapsing, such as three months. In various implementations, an analyst may instruct the operation of determining error for a plurality of transfer coefficients to identify which transfer coefficients result in the least error. Control continues to 504 to identify a previous threshold time, a first timeframe, and a second timeframe based on historical data. That is, control identifies two, consecutive timeframes, a first and a second, within a previous threshold time (such as one year) to forecast sales and compare the forecast sales to actual sales to determine the most accurate transfer coefficients for use in sales prediction. Control proceeds to 506 to obtain historical item transaction data over a previous threshold time for a set of items, for example, the predetermined interval elapsing may occur with respect to a particular store and the set of items obtained corresponding to historical item transactions from the particular store over the previous threshold time.

Control continues to 508 to obtain an action for each item of the set of items including new to store, existing, or deleted. The action corresponding to whether the item is new to store over the previous threshold time (for example, at any point in time), remains existing during the previous threshold time, or was removed during the previous threshold time (or specifically removed during the second timeframe). Control proceeds to 510 to identify a set of categories based on the set of items. That is, each item corresponds to a particular category, such as a coffee maker may be included in a kitchen appliances category. Control proceeds to 512 to compute a weekly category sales index for each category during the previous threshold time by dividing weekly sales of items in each category by average sales of the corresponding category.

Control continues to 514 to select a first item of the set of items. At 516, control determine if the action of the selected item indicates the selected item is new to store. If no, control proceeds to 518 to de-season weekly item sales for a first timeframe by dividing actual item sales for each week by the corresponding weekly category sales index. Then, control continues to 520 to determine an average de-seasoned sales of the de-seasoned weekly item sales for the first timeframe. Control proceeds to 522 to compute, for each week of the second timeframe, a weekly forecast as the de-seasoned weekly item sales corresponding to each week of the second timeframe by the average of the de-seasoned weekly sales determined in 520. Control proceeds to 524 to compute a base sales forecast for the second timeframe of the selected item by summing the weekly forecasts of the second timeframe. Then, control continues to 526 to determine if another item is included in the set of items.

Returning to 516, if control determines that the action indicates the item is new to store, then control proceeds to 528 to identify a set of similar stores with historical data for the selected item. That is, control identifies stores similar to the particular store based on location, size, sales, etc. Control continues to 530 to calculate, for each store of the set of similar stores, proportional sales of the selected item as the selected item sales at the similar store divided by the overall sales of the similar store. Control continues to 532 to determine an average of the proportional sales for the selected item across the set of similar stores. Then, control continues to 534 to compute a base sales forecast for a previous year for the selected item by multiplying the average proportional sales by the present store overall item sales for the year. Control proceeds to 536 to adjust the base sales forecast to a length of the second timeframe, for example, reduce the number of sales to be proportional to the number of weeks within the second timeframe.

Control continues to 526 to determine if another item is included in the set of items. If yes, control continues to 538 to select a next item of the set of items and returns to 516. Otherwise, if no, control continues to 540 to select a first set of transfer coefficients from a database. As described previously, a plurality of transfer coefficients are generated over a range of values and combinations of transfer coefficient parameters and stored in a database. Control proceeds to 542 to select a first item of the set of items. Control proceeds to 544 to compute a nominal demand for new to store items using the corresponding base sales forecast, corresponding transfer coefficients, and similarity between new to store items (indicated by the existence of a transfer coefficient to a present new to store item from another new to store item). As also previously described, transfer coefficients are calculated for items that are similar and may result in a demand transfer from one item to another. At 544, control calculates nominal demand for new to store items if a transfer coefficient exists for a new to store item from another (or multiple) new to store item, as described with respect to FIG. 3.

Control proceeds to 546 to compute nominal demand for existing items based on corresponding base forecast sales of the existing item, nominal demand of new to store items, corresponding transfer coefficients, and similarity to new to store items (indicated by the existence of a transfer coefficient to the existing item from the new to store item). As described above, the nominal demand is based on only those transfer coefficients to the existing item from the new to store item, described in detail in FIG. 3. Control continues to 548 to compute the demand transfer for deleted items as the sum of nominal demand of existing or new items to which the demand for the deleted item will transfer multiplied by the corresponding transfer coefficient, also described in detail in FIG. 3. Control proceeds to 550 to compute demand transfer for existing items as the base sales forecast subtracted by the corresponding nominal demand. Then, at 552, control computes a final forecast for all items as the nominal demand plus the demand transfer of deleted items, minus the demand transfer of existing items. In various implementations, the demand transfer of deleted items is added to those existing or new items to which the demand switches.

Control proceeds to 554 to compute the error using actual sales versus final forecast for each item. As previously mentioned, control may determine the error using mean absolute percentage error. Control continues to 556 to determine if another item is in the set of items. If yes, control continues to 558 to select a next item of the set of items and returns to 544. Otherwise, if no, control continues to 560 to transmit the error for each item of the set of items and the transfer coefficient parameters or corresponding transfer coefficients for storage. Then, control continues to 562 to determine if another set of transfer coefficients is in the database. If yes, control continues to 564 to select a next set of transfer coefficients and return to 542. Otherwise, control ends.

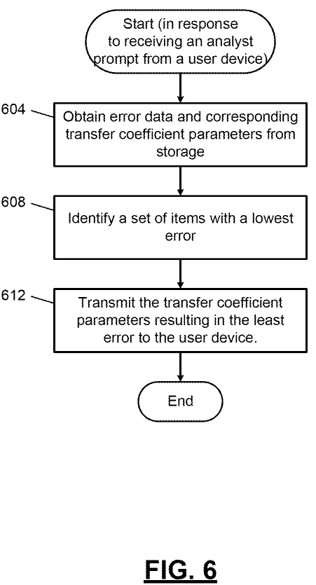

Referring to FIG. 6, a flowchart of example methods of tuning parameters based on the forecasted demand error is shown. Control begins in response to receiving an analyst prompt from a user device. In various implementations, control may begin after receiving an automated indication that all variations of transfer coefficients have been executed to determine all variations of error for forecasting. Control proceeds to 604 to obtain error data and corresponding transfer coefficient parameters from storage. Control continues to 608 to identify a set of items with a lowest error within a set of transfer coefficients corresponding to transfer coefficient parameters. Control proceeds to 612 to transmit the corresponding transfer coefficient parameters resulting in the least error to the user device. Then, control ends.

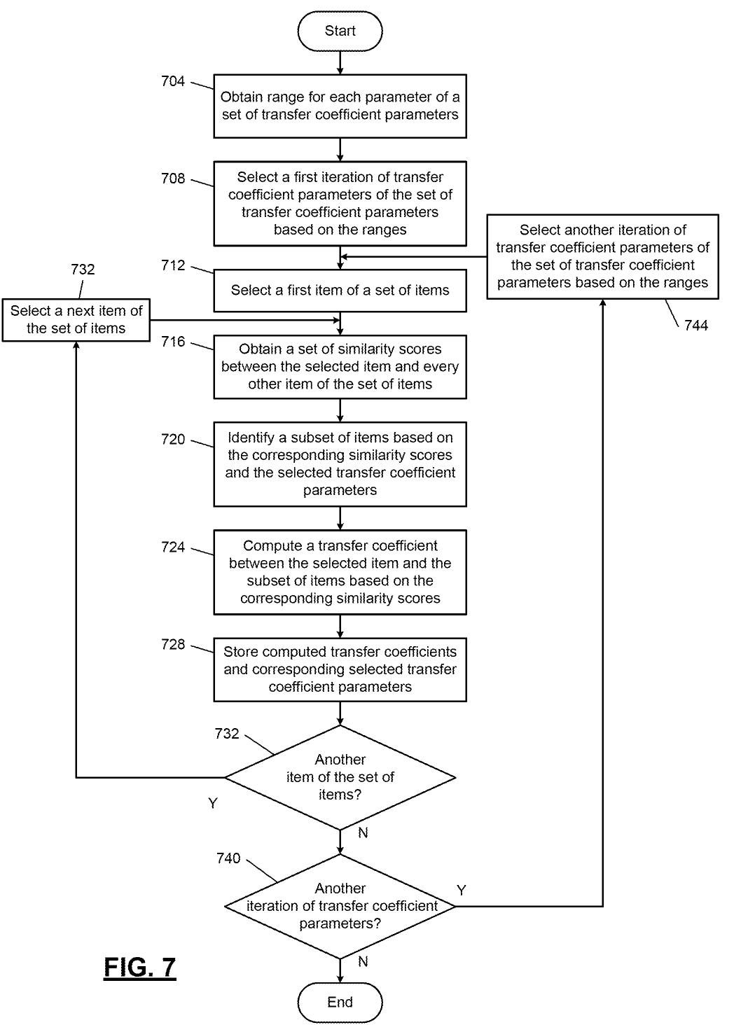

Referring to FIG. 7, a flowchart of example methods of generating transfer coefficients for a variety of transfer coefficient parameters is shown. Control begins at 704 and obtains a range for each parameter of the set of transfer coefficient parameters. As described previously, the set of parameters may include a similarity score threshold, a threshold number of items, a threshold percentage of items, and a percentage similarity score threshold of a most similar item. In various implementations, the ranges may be received from a user device operated by an analyst, prompting the update of which transfer coefficients result in the most accurate forecasting. Control continues to 708 to select a first iteration of transfer coefficient parameters of the set of transfer coefficient parameters based on the ranges. Control proceeds to 712 to select a first item of a set of items. The set of items represent the set of items available at any point in time over the previous threshold period (for example, as obtained from the historical database 132 or the item database 140).

Control continues to 716 to obtain a set of similarity scores between the selected item and every other item of the set of items, for example, from the similarity database 144. Control continues to 720 to identify a subset of items based on the corresponding similarity scores and the selected transfer coefficient parameters. At 724, control computes a transfer coefficient between the selected item and the subset of items based on the corresponding similarity scores. As previously described, the transfer coefficient is computed as proportional to the similarity scores of each item of the subset of items that is identified as similar described in FIG. 1. Control continues to 728 to store the computed transfer coefficients and corresponding selected transfer coefficient parameters. Control proceeds to 732 to determine if another item is in the set of items. If yes, control continues to 736 to select a next item of the set of items and return to 716. Otherwise, if no other items are in the set of items, control continues to 740 to determine if another iteration exists in the range of transfer coefficient parameters. If no, control ends. Otherwise, if yes, control continues to 744 to select another iterations of transfer coefficient parameters of the set of transfer coefficient parameters based on the ranges and returns to 712.

Although the methods described above are with reference to the illustrated flowcharts, it will be appreciated that many other ways of performing the acts associated with the methods can be used. For example, the order of some operations may be changed, and some of the operations described may be optional.

In addition, the methods and system described herein can be at least partially embodied in the form of computer-implemented processes and apparatus for practicing those processes. The disclosed methods may also be at least partially embodied in the form of tangible, non-transitory machine-readable storage media encoded with computer program code. For example, the steps of the methods can be embodied in hardware, in executable instructions executed by a processor (e.g., software), or a combination of the two. The media may include, for example, RAMs, ROMs, CD-ROMs, DVD-ROMs, BD-ROMs, hard disk drives, flash memories, or any other non-transitory machine-readable storage medium. When the computer program code is loaded into and executed by a computer, the computer becomes an apparatus for practicing the method. The methods may also be at least partially embodied in the form of a computer into which computer program code is loaded or executed, such that, the computer becomes a special purpose computer for practicing the methods. When implemented on a general-purpose processor, the computer program code segments configure the processor to create specific logic circuits. The methods may alternatively be at least partially embodied in application specific integrated circuits for performing the methods.

The term model as used in the present disclosure includes data models created using machine learning. Machine learning may involve training a model in a supervised or unsupervised setting. Machine learning can include models that may be trained to learn relationships between various groups of data. Machine learned models may be based on a set of algorithms that are designed to model abstractions in data by using a number of processing layers. The processing layers may be made up of non-linear transformations. The models may include, for example, artificial intelligence, neural networks, deep convolutional and recurrent neural networks. Such neural networks may be made of up of levels of trainable filters, transformations, projections, hashing, pooling and regularization. The models may be used in large-scale relationship-recognition tasks. The models can be created by using various open-source and proprietary machine learning tools known to those of ordinary skill in the art.

The foregoing is provided for purposes of illustrating, explaining, and describing embodiments of these disclosures. Modifications and adaptations to these embodiments will be apparent to those skilled in the art and may be made without departing from the scope or spirit of these disclosures.

What is claimed is:

1. A system comprising:
a computing device configured to:
identify a timeframe including a first time period and a second time period;
obtain historical data for a set of items over the timeframe and a plurality of sets of transfer coefficients, the historical data including an action indication;
based on the historical data, compute a weekly index for each week within the timeframe;
for each item of the set of items:
compute a base forecast during the second time period based on the action indication, the weekly index, and historical data indicating a number of corresponding item transactions during the first time period;
for each set of transfer coefficients of the plurality of sets of transfer coefficients, adjust the base forecast based on the action indication; and
compute an error value;
select a first set of transfer coefficients of the plurality of sets of transfer coefficients based on the error value for each item of the set of items; and
implement a demand forecasting device using the first set of transfer coefficients.

2. The system of claim 1, wherein the first time period and the second time period are consecutive and a length of the first time period equals a length of the second time period.

3. The system of claim 1, wherein the weekly index is determined by:
identifying a set of categories based on the set of items;
selecting, from the historical data, for each week over the timeframe, a number of transactions for each item within a first category of the set of categories;
determining an average number of transactions for each item within the first category across a number of weeks within the timeframe; and
for each week over the timeframe, dividing the number of transactions for the corresponding week by the average number of transactions.

4. The system of claim 3, wherein each item of the set of items corresponds to a category of the set of categories.

5. The system of claim 1, wherein the computing device is configured to, in response to a first action of a first item of the set of items indicating the first item is new, compute the base forecast by:
identifying a set of stores similar to a store corresponding to the set of items;
computing a proportional sale of the first item to items in each store of the set of stores;
computing an average proportional sale of the proportional sale for each store of the set of stores; and
determining the base forecast as the average proportional sale multiplied by item sales in the store.

6. The system of claim 1, wherein the computing device is configured to, in response to a first action of a first item of the set of items indicating the first item is existing or deleted, compute the base forecast by:
for each week of the first time period:
determining a number of transactions of the first item; and
dividing the number of transactions by a corresponding weekly index to determine de-seasoned weekly transactions;
averaging the de-seasoned weekly transactions;
for each week of the second time period:
computing a weekly base forecast as the average de-seasoned weekly transactions multiplied by a corresponding de-seasoned weekly transaction of the first time period; and
summing the weekly base forecast for each week of the second time period as the base forecast for the first item.

7. The system of claim 1, wherein the computing device is configured to determine each set of transfer coefficients of the plurality of sets of transfer coefficients by:
determining the plurality of sets of transfer coefficient parameters based on at least one parameter range; and
for each set of transfer coefficient parameters of the plurality of sets of transfer coefficient parameters and for each item of the set of items:
obtaining similarity scores between the corresponding item and each other item of the set of items;
applying the corresponding set of transfer coefficients to remove filter similarity scores; and
for item pairs corresponding to similarity scores, computing a corresponding transfer coefficient between a first item and items corresponding to similarity scores with the first item as a weighted similarity score.

8. A method comprising:
identifying a timeframe including a first time period and a second time period;
obtaining historical data for a set of items over the timeframe and a plurality of sets of transfer coefficients, the historical data including an action indication;
based on the historical data, computing a weekly index for each week within the timeframe;
for each item of the set of items:
computing a base forecast during the second time period based on the action indication, the weekly index, and historical data indicating a number of corresponding item transactions during the first time period;
for each set of transfer coefficients of the plurality of sets of transfer coefficients, adjusting the base forecast based on the action indication; and
computing an error value;
selecting a first set of transfer coefficients of the plurality of sets of transfer coefficients based on the error value for each item of the set of items; and
implementing a demand forecasting device using the first set of transfer coefficients.

9. The method of claim 8, wherein the first time period and the second time period are consecutive and a length of the first time period equals a length of the second time period.

10. The method of claim 8, wherein the weekly index is determined by:
identifying a set of categories based on the set of items;
selecting, from the historical data, for each week over the timeframe, a number of transactions for each item within a first category of the set of categories;
determining an average number of transactions for each item within the first category across a number of weeks within the timeframe; and
for each week over the timeframe, dividing the number of transactions for the corresponding week by the average number of transactions.

11. The method of claim 10, wherein each item of the set of items corresponds to a category of the set of categories.

12. The method of claim 8, further comprising, in response to a first action of a first item of the set of items indicating the first item is new, computing the base forecast by:
identifying a set of stores similar to a store corresponding to the set of items;
computing a proportional sale of the first item to items in each store of the set of stores;
computing an average proportional sale of the proportional sale for each store of the set of stores; and
determining the base forecast as the average proportional sale multiplied by item sales in the store.

13. The method of claim 8, further comprising, in response to a first action of a first item of the set of items indicating the first item is existing or deleted, computing the base forecast by:
for each week of the first time period:
determining a number of transactions of the first item; and
dividing the number of transactions by a corresponding weekly index to determine de-seasoned weekly transactions;
averaging the de-seasoned weekly transactions;
for each week of the second time period:
computing a weekly base forecast as the average de-seasoned weekly transactions multiplied by a corresponding de-seasoned weekly transaction of the first time period; and
summing the weekly base forecast for each week of the second time period as the base forecast for the first item.

14. The method of claim 8, further comprising determining each set of transfer coefficients of the plurality of sets of transfer coefficients by:
determining the plurality of sets of transfer coefficient parameters based on at least one parameter range; and
for each set of transfer coefficient parameters of the plurality of sets of transfer coefficient parameters and for each item of the set of items:
obtaining similarity scores between the corresponding item and each other item of the set of items;
applying the corresponding set of transfer coefficients to remove filter similarity scores; and
for item pairs corresponding to similarity scores, computing a corresponding transfer coefficient between a first item and items corresponding to similarity scores with the first item as a weighted similarity score.

15. A non-transitory computer readable medium having instructions stored thereon, wherein the instructions, when executed by at least one processor, cause a device to perform operations comprising:
identifying a timeframe including a first time period and a second time period;
obtaining historical data for a set of items over the timeframe and a plurality of sets of transfer coefficients, the historical data including an action indication;
based on the historical data, computing a weekly index for each week within the timeframe;
for each item of the set of items:
computing a base forecast during the second time period based on the action indication, the weekly index, and historical data indicating a number of corresponding item transactions during the first time period;
for each set of transfer coefficients of the plurality of sets of transfer coefficients, adjusting the base forecast based on the action indication; and
computing an error value;
selecting a first set of transfer coefficients of the plurality of sets of transfer coefficients based on the error value for each item of the set of items; and
implementing a demand forecasting device using the first set of transfer coefficients.

16. The non-transitory computer-readable medium of claim 15, wherein the first time period and the second time period are consecutive and a length of the first time period equals a length of the second time period.

17. The non-transitory computer-readable medium of claim 15, wherein the weekly index is determined by:
identifying a set of categories based on the set of items;
selecting, from the historical data, for each week over the timeframe, a number of transactions for each item within a first category of the set of categories;
determining an average number of transactions for each item within the first category across a number of weeks within the timeframe;
for each week over the timeframe, dividing the number of transactions for the corresponding week by the average number of transactions.

18. The non-transitory computer-readable medium of claim 17, wherein each item of the set of items corresponds to a category of the set of categories.

19. The non-transitory computer-readable medium of claim 17, further comprising, in response to a first action of a first item of the set of items indicating the first item is new, computing the base forecast by:
identifying a set of stores similar to a store corresponding to the set of items;
computing a proportional sale of the first item to items in each store of the set of stores;
computing an average proportional sale of the proportional sale for each store of the set of stores; and
determining the base forecast as the average proportional sale multiplied by item sales in the store.

20. The non-transitory computer-readable medium of claim 17, further comprising, in response to a first action of a first item of the set of items indicating the first item is existing or deleted, computing the base forecast by:
for each week of the first time period:
determining a number of transactions of the first item; and
dividing the number of transactions by a corresponding weekly index to determine de-seasoned weekly transactions;
averaging the de-seasoned weekly transactions;
for each week of the second time period:
computing a weekly base forecast as the average de-seasoned weekly transactions multiplied by a corresponding de-seasoned weekly transaction of the first time period; and
summing the weekly base forecast for each week of the second time period as the base forecast for the first item.
